(19) United States
(12) Patent Application Publication
(10) Pub. No.: US 2019/0275706 A1
(43) Pub. Date: Sep. 12, 2019

(54) Molding Material, Assembly of Molding Materials, Method for Producing Molding Material, and Method for Producing Assembly of Molding Materials

(71) Applicant: Teijin Limited, Osaka-Shi, Osaka (JP)

(72) Inventors: Daisuke Kobayashi, Osaka-shi (JP); Guofei Hua, Osaka-shi (JP)

(73) Assignee: Teijin Limited, Osaka-Shi, Osaka (JP)

(21) Appl. No.: 16/346,667

(22) PCT Filed: Oct. 17, 2017
(86) PCT No.: PCT/JP2017/037589

§ 371 Date: May 1, 2019

(30) Foreign Application Priority Data
Nov. 1, 2016 (JP) 2016-214221

(51) Int. Cl. B29B 15/12; B29B 9/14; B29B 15/14; B29C 45/00; C08J 3/12; C08J 5/06

(52) U.S. Cl. CPC B29B 15/122; B29B 9/14; C08J 5/06; B29C 45/0005; C08J 3/12; B29B 15/14

(57) ABSTRACT

The present invention provides an assembly of molding materials, each of which is obtained by covering a carbon fiber bundle that contains an impregnation assistant with a thermoplastic resin. This assembly of molding materials is configured such that 30% or more of the whole assembly is a molding material that satisfies 100≤F/L (N/m), where L is the molding material length in the axial direction of the carbon fiber bundle and F is the grip force of the carbon fiber bundle with respect to the molding material. Consequently, falling-off of carbon fibers from the molding materials during injection molding is able to be prevented, so that a molded body is able to be produced with high production efficiency.

### TECHNICAL FIELD

The present invention relates to a molding material in which a carbon fiber bundle containing an impregnation aid is covered with a thermoplastic resin, an assembly of the molding materials, a method for producing the molding material, and a method for producing the assembly of the molding materials.

### BACKGROUND ART

As means for obtaining a resin material having high strength and reduced brittle fracture, it is known that a resin is made into a composite material reinforced with a carbon fiber. Particularly, the composite material obtained by reinforcing a thermoplastic resin as a matrix resin with a carbon fiber is excellent in easy processability and recyclability as a molding material, and is expected to be applied to various fields.

For example, Patent Literature 1 proposes a molding material in which a carbon fiber bundle having an impregnation aid attached thereto is covered with a polycarbonate resin and the covered body is cut into pellets, making carbon fibers being easily dispersed during melt-kneading of injection molding. Patent Literature 2 proposes a molding material in which a carbon fiber bundle having a phenolic resin attached thereto is covered with a polycarbonate resin.

### CITATION LIST

### Patent Literature

Patent Literature 1: WO 2013/137246

Patent Literature 2: JP-A-2014-159560

### SUMMARY OF INVENTION

### Technical Problem

However, in the molding materials described in Patent Literature 1 and Patent Literature 2, when the carbon fiber bundle covered with a resin is cut, the carbon fibers fall out (fall off), causing a decrease in productivity. Thus, a molding material having higher productivity and excellent handleability is required.

Accordingly, objects of the present invention are to provide a molding material which solves the problems of the related-art molding material, prevents falling off of carbon fibers from the molding material and has improved productivity and handleability, to provide an assembly of the molding materials, to provide a method for producing the molding material, and to provide a method for producing the assembly of the molding materials.

### Solution to Problem

In order to solve the above problems, the present invention provides the following means.

<1> An assembly of molding materials, each of which contains a carbon fiber bundle containing an impregnation aid; and a thermoplastic resin covering the carbon fiber bunde,

wherein 30% or more of the molding materials in the assembly satisfy 100≤F/L (N/m), wherein L represents a length of each molding material in an axial direction of the carbon fiber bundle, and F represents a grip force of the carbon fiber bundle to the molding material.

<2> The assembly of molding materials according to <1>, wherein the molding material has a core-sheath structure in which the carbon fiber bundle is covered with a thermoplastic resin, and an axial length of the carbon fiber bundle is substantially the same as the length of the molding material.

<3> The assembly of molding materials according to <2>, wherein each of the molding materials satisfies the following Formula (1) when the molding material cut in an axial center direction thereof is observed.

0.4≤(area of carbon single fiber)×(number of single fibers in carbon fiber bundle)/(area surrounded by inner periphery of thermoplastic resin)≤0.9 (1)

Here, the area surrounded by the inner periphery of the thermoplastic resin is an average value of the molding materials in the assembly.

<4> The assembly of molding materials according to any one of <1> to <3>, wherein the impregnation aid is one or more selected from the group consisting of a phosphate ester and an aliphatic hydroxycarboxylic acid-based polyester.

<5> The assembly of molding materials according to any one of <1> to <4>, wherein the impregnation aid is a solid substance at 20° C.

<6> The assembly of molding materials according to any one of <1> to <5>, satisfying the following Formula (2):

0.1≤|K₁−K₂| (2)

wherein, K₁ (10⁻⁴/° C.) represents a linear expansion coefficient of the thermoplastic resin, and K₂ (10⁻⁴/° C.) represents a linear expansion coefficient of the impregnation aid.

<7> The assembly of molding materials according to any one of <1> to <6>, satisfying the following Formula (3):

|S₁−S₂|<1.5 (3)

wherein, S₁ ((cal/cm³)^{1/2}) represents a solubility parameter (SP) value of the thermoplastic resin, and S₂ ((cal/cm³)^{1/2}) represents an SP value of the impregnation aid.

<8> The assembly of molding materials according to any one of <1> to <7>, wherein axial lengths of the carbon fiber bundles are 1 mm to 30 mm.

<9> The assembly of molding materials according to any one of <2> to <8>, wherein the thermoplastic resin contains an amorphous resin.

<10> The assembly of molding materials according to any one of <2> to <9>, wherein the thermoplastic resin contains a polycarbonate.

<11> The assembly of molding materials according to any one of <1> to <10>, wherein the carbon fiber bundles are not impregnated with the thermoplastic resin.

<12> The assembly of molding materials according to any one of <1> to <11>, wherein 30% or more of the molding materials in the assembly satisfy F/L (N/m)<100,000.

<13> The assembly of molding materials according to any one of <1> to <12>,

wherein the carbon fiber bundles satisfy 0.001≤W (wt %)<0.4, wherein W (wt %) is a water content ratio in the carbon fiber bundles containing the impregnation aid.

<14> The assembly of molding materials according to any one of <1> to <13>, wherein a ratio of D₁/D₂ is 1.1 or more and 1.8 or less, wherein D₁ represents a long diameter D₁ of a cross section shape of the the molding material cut along a direction orthogonal to the axial direction of the carbon fiber bundle, and D₂ represents a short diameter D₂ of the cross section shape.

<15> A method for producing a molding material having a core-sheath-structure in which a carbon fiber bundle containing an impregnation aid is covered with a thermoplastic resin, the method including: covering the carbon fiber bundle with the thermoplastic resin to be integrated in a heated state where the carbon fiber bundle is heated to a temperature equal to or higher than a melting point of the impregnation aid when the impregnation aid is a crystalline resin, or heating the carbon fiber bundle to a temperature equal to or higher than a glass transition temperature of the impregnation aid when the impregnation aid is an amorphous resin.

<16> A method for producing an assembly of molding materials which are produced using the method for producing a molding material according to <15>, wherein 30% or more of the molding materials in the assembly satisfy 100≤F/L (N/m)≤100,000,

wherein L represents a length of the molding material in an axial direction of the carbon fiber bundle, and

F represents a grip force of the carbon fiber bundle to the molding material.

<17> The method for producing a molding material according to <15>, further including:

cooling a covered body produced by covering the carbon fiber bundle with the thermoplastic resin to be integrated to be equal to or lower than the glass transition temperature of the thermoplastic resin; and

cutting the covered body to produce the molding material.

<18> The method for producing a molding material according to <15> or <17>, wherein

a water content ratio in the carbon fiber bundle containing the impregnation aid W (wt %) satisfies 0.001≤W (wt %)<0.4.

<19> A molding material including: a carbon fiber bundle containing an impregnation aid; and a thermoplastic resin covering the carbon fiber bundle,

wherein the molding material satisfies 80≤F/L (N/m), wherein L represents a length of the molding material in an axial direction of the carbon fiber bundle, and F represents a grip force of the carbon fiber bundle to the molding material.

<20> The molding material according to <19>, wherein the molding material has a core-sheath structure in which the carbon fiber bundle is covered with the thermoplastic resin, and an axial length of the carbon fiber bundle is substantially the same as the length of the molding material.

<21> The molding material according to <20>, wherein the molding material satisfies the following Formula (1) when the molding material cut in an axial center direction thereof is observed:

0.4≤(area of carbon single fiber)×(number of single fibers in carbon fiber bundle)/(area surrounded by inner periphery of thermoplastic resin)≤0.9 (1).

<22> The molding material according to any one of <19> to <21>, wherein the impregnation aid is one or more selected from the group consisting of a phosphate ester and an aliphatic hydroxycarboxylic acid-based polyester.

<23> The molding material according to any one of <19> to <22>, wherein the impregnation aid is a solid substance at 20° C.

<24> The molding material according to any one of <19> to <23>, satisfying the following Formula (2):

0.1≤|K₁−K₂| (2)

wherein, K₁ (10⁻⁴/° C.) represents a linear expansion coefficient of the thermoplastic resin, and

K₂ (10⁻⁴/° C.) represents a linear expansion coefficient of the impregnation aid.

<25> The molding material according to any one of <19> to <24>, satisfying the following Formula (3):

|S₁−S₂|<1.5 (3)

wherein S₁ ((cal/cm³)^{1/2}) represents a solubility parameter (SP) value of the thermoplastic resin, and

S₂ ((cal/cm³)^{1/2}) represents an SP value of the impregnation aid.

<26> The molding material according to any one of <19> to <25>, wherein an axial length of the carbon fiber bundle is 1 mm to 30 mm.

<27> The molding material according to any one of <19> to <26>, wherein the thermoplastic resin contains an amorphous resin.

<28> The molding material according to any one of <19> to <27>, wherein the thermoplastic resin contains a polycarbonate.

<29> The molding material according to any one of <19> to <28>, wherein the carbon fiber bundle is not impregnated with the thermoplastic resin.

<30> The molding material according to any one of <19> to <29>, satisfying F/L (N/m)<100,000.

<31> The molding material according to any one of <19> to <30>,

wherein the carbon fiber bundle satisfies 0.001≤W (wt %)<0.4,

wherein W (wt %) represents a water content ratio in the carbon fiber bundle containing the impregnation aid.

<32> The molding material according to any one of <19> to <31>, wherein a ratio of D₂/D₁ is 1.1 to 1.8,

wherein D₁ represents a long diameter D₁ of a cross section shape of t the molding material cut along a direction orthogonal to the axial direction of the carbon fiber bundle, and

D₂ represents a short diameter D₂ of the cross section shape.

### Advantageous Effects of Invention

When the assembly of the molding materials according to the present invention is used, it is possible to prevent the carbon fibers from falling off from the molding material during injection molding and to produce a molded body with high production efficiency. In addition, when the assembly of the molding materials according to the present invention is used, troubles in molding such as clogging in a hopper dryer of a molding machine during injection molding are reduced and the handleability is excellent.

### BRIEF DESCRIPTION OF DRAWINGS

FIG. 1 shows an example of a molding material according to the present invention.

FIG. 2 shows an example in which carbon fibers are fallen off from the molding material.

FIG. 3 shows a cross sectional view (a YZ cross section in FIG. 1) of the molding material according to the present invention.

FIG. 4 shows an example of a cross section (a YZ cross section in FIG. 2) of the molding material in which carbon fibers fall off from the molding material.

### DESCRIPTION OF EMBODIMENTS

### [Carbon Fibers]

The carbon fibers contained in the molding material according to the present invention may be any carbon fibers such as polyacrylonitrile (PAN)-based carbon fibers, petroleum/petroleum pitch-based carbon fibers, rayon-based carbon fibers, and lignin-based carbon fibers. Particularly, PAN-based carbon fibers using PAN as a raw material are preferred because of having excellent productivity and mechanical properties on a factory scale. Carbon fibers containing carbon single fibers having an average diameter of 5 μm to 10 μm can be preferably used as the carbon fibers. General carbon fibers are carbon fiber filaments in which 1000 to 50,000 single fibers (single yarns) form a fiber bundle. The carbon fiber bundle in the present invention also contains such general carbon fiber filaments, and also contains doubled yarn obtained by further doubling and winding the carbon fiber filaments, and twisted yarns obtained by twisting the doubled yarns. In order to enhance the adhesion between the carbon fibers and the polycarbonate, the carbon fibers contained in the molding material according to the present invention preferably have an oxygen-containing functional group introduced onto the surface thereof by surface treatment.

As described above, in order to stabilize a step of uniformly adhering an impregnation aid to a carbon fiber bundle in a case of making an easily impregnated carbon fiber bundle by soaking the carbon fiber bundle with the impregnation aid, the carbon fiber bundle is preferably treated with a sizing agent for providing convergence. Known sizing agents for producing carbon fiber filaments can be used as the sizing agent. The carbon fiber bundle can be used in the present invention without problems even when an oil agent used for improving the slidability during production remains. Hereinafter, in the sense of a superordinate concept including an impregnation aid and other surface treatment agents such as the above sizing agent, an expression of “surface treatment agent” may be used.

### [Impregnation Aid]

The impregnation aid used in the present invention is not particularly limited, and may be one type or plural types of impregnation aids.

The impregnation aid used in the present invention is preferably one or more selected from the group consisting of a phosphate ester and an aliphatic hydroxycarboxylic acid-based polyester, and, of course, may contain both a phosphate ester and an aliphatic hydroxycarboxylic acid-based polyester.

In the present invention, the phosphate ester is not particularly limited in a case where the phosphate ester is used as the impregnation aid, and examples thereof include a blend of phosphate ester monomers or oligomeric phosphates, specifically aromatic phosphates typified by trimethyl phosphate, triethyl phosphate, tributyl phosphate, trioctyl phosphate, tributoxyethyl phosphate, triphenyl phosphate, and the like. Preferred is trimethyl phosphate or triphenyl phosphate.

In the present invention, in a case where the aliphatic hydroxycarboxylic acid-based polyester is used as the impregnation aid, the aliphatic hydroxycarboxylic acid-based polyester is a polyester containing aliphatic hydroxycarboxylic acid residues, and may be a homopolymerized polyester containing a single aliphatic hydroxycarboxylic acid residue or a copolymerized polyester containing plural kinds of aliphatic hydroxycarboxylic acid residues. In addition, the aliphatic hydroxycarboxylic acid-based polyester may be a copolymerized polyester containing residues other than an aliphatic hydroxycarboxylic acid residue, such as a diol residue and a dicarboxylic acid residue, in an amount of less than 50 mol % of the residues constituting the polymer, and is preferably a homopolymer to which a comonomer component is not intentionally added from the viewpoint of easy availability. The aliphatic hydroxycarboxylic acid-based polyester also contains a lactone-based polymer which is a compound generated by dehydration condensation of a hydroxyl group and a carboxyl group in the same molecule.

In the present invention, the aliphatic hydroxycarboxylic acid-based polyester usable as the impregnation aid is not particularly limited. The aliphatic hydroxycarboxylic acid-based polyester is preferably a homopolymer of ε-caprolactone, δ-caprolactone, β-propiolactone, γ-butyrolactone, δ-valerolactone, γ-valerolactone and enantolactone, and copolymers of these two or more monomers, and is more preferably one or more selected from the group consisting of a homopolymer of ε-caprolactone, δ-caprolactone, β-propiolactone, γ-butyrolactone, δ-valerolactone, γ-valerolactone and enantolactone, having a weight average molecular weight of 3,000 to 50,000, and copolymers of these two or more monomers having a weight average molecular weight of 3,000 to 50,000. Particularly preferred is a homopolymer of ε-caprolactone or δ-caprolactone, having a weight average molecular weight of 3,000 to 50,000. When referring to the lactone-based polymer in the present invention, a polymer obtained by ring-opening polymerization of lactones and a polymer having the same structure using an aliphatic hydroxycarboxylic acid, which is an equivalent of the lactone, and a derivative thereof as a raw material are also included.

The amount of the impregnation aid contained in the carbon fiber bundle is not particularly limited, and is preferably 3 parts by mass to 15 parts by mass, and more preferably 5 parts by mass to 12 parts by mass, based on 100 parts by mass of the carbon fibers.

### [Thermoplastic Resin]

Examples of the thermoplastic resin used in the present invention can include a polyolefin resin, a polystyrene resin, a thermoplastic polyamide resin, a polyester resin, a polyacetal resin (polyoxymethylene resin), a polycarbonate resin, a (meth)acrylic resin, a polyarylate resin, a polyphenylene ether resin, a polyimide resin, a polyether nitrile resin, a phenoxy resin, a polyphenylene sulfide resin, a polysulfone resin, a polyketone resin, a polyether ketone resin, a thermoplastic urethane resin, a fluorine resin, a thermoplastic polybenzimidazole resin, a vinyl resin, or the like.

Examples of the polyolefin resin can include a polyethylene resin, a polypropylene resin, a polybutadiene resin, a polymethylpentene resin, or the like. Examples of the vinyl resin can include a vinyl chloride resin, a vinylidene chloride resin, a vinyl acetate resin, a polyvinyl alcohol resin, or the like. Examples of the polystyrene resin can include a polystyrene resin, an acrylonitrile-styrene resin (an AS resin), an acrylonitrile-butadiene-styrene resin (an ABS resin), or the like. Examples of the polyamide resin can include a polyamide 6 resin (nylon 6), a polyamide 11 resin (nylon 11), a polyamide 12 resin (nylon 12), a polyamide 46 resin (nylon 46), a polyamide 66 resin (nylon 66), a polyamide 610 resin (nylon 610), or the like. Examples of the polyester resin can include a polyethylene terephthalate resin, a polyethylene naphthalate resin, a polybutylene terephthalate resin, a polytrimethylene terephthalate resin, a liquid crystal polyester, or the like. Examples of the (meth)acrylic resin can include polymethyl methacrylate or the like. Examples of the polyphenylene ether resin can include modified polyphenylene ether or the like. Examples of the polyimide resin can include a thermoplastic polyimide, a polyamide imide resin, a polyether imide resin, or the like. Examples of the polysulfone resin can include a modified polysulfone resin, a polyethersulfone resin, or the like. Examples of the polyetherketone resin can include a polyetherketone resin, a polyetheretherketone resin, a polyetherketoneketone resin, or the like. Examples of the fluorine resin can include polytetrafluoroethylene.

The thermoplastic resin used in the present invention may be of only one type, or may be of two or more types. In the present invention, examples of a mode in which two or more types of thermoplastic resin are used in combination can include a mode in which thermoplastic resins having different softening points or melting points are used in combination or a mode in which thermoplastic resins having different average molecular weights are used in combination, and are not limited thereto.

### [Amorphous Resin]

The thermoplastic resin in the present invention is preferably a resin containing an amorphous resin. As to be described later, in a case where the molding material has a core-sheath structure in which the carbon fiber bundle is covered with the thermoplastic resin, the carbon fiber bundle is covered with the thermoplastic resin in a molten state and then the covered body is cooled, so as to produce a molding material. In cooling, a cooling difference occurs between an outer peripheral side and an inner peripheral side of the thermoplastic resin, and shrinkage of the thermoplastic resin occurs. The covered body is cooled from the outside of the thermoplastic resin and the thermoplastic resin shrinks toward the outside. As a result, in a case where the molding material has a core-sheath structure, gaps tend to be formed in a core portion (portion of the carbon fiber bundle) in the center. When a resin containing an amorphous resin is used as the thermoplastic resin, the shrinkage ratio is lower than that of a crystalline resin, and the shrinkage of thermoplastic resin as a sheath component is small, so that the generation of the gaps in the core portion of the molding material can be suppressed.

### [Linear Expansion Coefficients of Thermoplastic Resin and Impregnation Aid]

The assembly of molding materials according to the present invention preferably satisfies the following Formula (2):

0.1<|K₁−K₂| (2)

where, K₁ (10⁻⁴/° C.) represents the linear expansion coefficient of the thermoplastic resin, and K₂ (10⁻⁴/° C.) represents the linear expansion coefficient of the impregnation aid.

Since a molding material satisfying the Formula (2) has a difference in linear expansion coefficient between the impregnation aid and the thermoplastic resin present around the impregnation aid, the carbon fibers are easy to fall out. However, the molding material according to the present invention satisfies the Formula (2), and the carbon fibers are difficult to fall out.

### [Solubility Parameter (SP) Value of Thermoplastic Resin]

The assembly of molding materials according to the present invention preferably satisfies the following Formula (3):

|S₁−S₂|<1.5 (3)

where, S₁ ((cal/cm³)^{1/2}) represents the solubility parameter (SP) value of the thermoplastic resin, and S₂ ((cal/cm³)^{1/2}) represents the SP value of the impregnation aid.

When the Formula (3) is satisfied, in covering the carbon fiber bundle containing the impregnation aid with the thermoplastic resin, a part of the impregnation aid and the thermoplastic resin are easily mixed, making the carbon fiber bundle less likely to fall out from the molding material.

### [Polycarbonate]

A resin containing polycarbonate is preferably used as the thermoplastic resin in the present invention. In this case, the type of the polycarbonate is not particularly limited, and examples thereof include those obtained by reacting various dihydroxyaryl compounds with phosgene or those obtained by a transesterification reaction between a dihydroxyaryl compound and diphenyl carbonate. Representative examples are polycarbonates obtained by the reaction of 2,2′-bis(4-hydroxyphenyl) propane, so-called bisphenol A, with phosgene or diphenyl carbonate.

Examples of the dihydroxyaryl compound used as a raw material of the polycarbonate include bis(4-hydroxyphenyl) methane, 1,1′-bis(4-hydroxyphenyl) ethane, 2,2′-bis(4-hydroxyphenyl) propane, 2,2′-bis(4-hydroxyphenyl) butane, 2,2′-bis(4-hydroxyphenyl) octane, 2,2′-bis(4-hydroxy-3-methylphenyl) propane, 2,2′-bis(4-hydroxy-3-t-butylphenyl) propane, 2,2′-bis(3,5-dimethyl-4-hydroxyphenyl) propane, 2,2′-bis(4-hydroxy-3-cyclohexylphenyl) propane, 2,2′-bis(4-hydroxy-3-methoxyphenyl) propane, 1,1′-bis(4-hydroxyphenyl)cyclopentane, 1,1′-bis(4-hydroxyphenyl)cyclohexane, 1,1′-bis(4-hydroxyphenyl)cyclododecane, 4,4′-dihydroxyphenyl ether, 4,4′-dihydroxy-3,3′-dimethylphenyl ether, 4,4′-dihydroxydiphenyl sulfide, 4,4′-dihydroxy-3,3′-dimethyl diphenyl sulfide, 4,4′-dihydroxydiphenyl sulfoxide, 4,4′-dihydroxydiphenyl sulfone, bis(4-hydroxyphenyl) ketone, or the like. These dihydroxyaryl compounds can be used alone or in combination of two or more types.

Preferred dihydroxyaryl compounds contain bisphenols, bis(hydroxyphenyl)alkanes such as 2,2′-bis(4-hydroxyphenyl) propane, bis(hydroxyphenyl)cycloalkanes such as bis(4-hydroxyphenyl)cyclohexane, dihydroxydiphenyl sulfide, dihydroxydiphenyl sulfone, and dihydroxydiphenyl ketone which form aromatic polycarbonates with high heat resistance.

Particularly preferred dihydroxyaryl compounds contain 2,2′-bis(4-hydroxyphenyl) propane forming bisphenol A type aromatic polycarbonates.

When producing a bisphenol A aromatic polycarbonate, a part of bisphenol A may be substituted with another dihydroxyaryl compound within a range not impairing heat resistance, mechanical strength and the like. In addition, for the purpose of increasing flowability, appearance gloss, flame retardancy, thermal stability, weather resistance, impact resistance or the like, various polymers, fillers, stabilizers, pigments or the like may be blended within a range not impairing mechanical strength. For the purpose of improving flame retardancy, it is also possible to incorporate a phosphate ester as a flame retardant into the polycarbonate.

### [Molding Material]

The molding material according to the present invention is one in which the carbon fiber bundle containing an impregnation aid is covered with a thermoplastic resin, and is usually in the form of a granule. The molding material preferably has a core-sheath structure in which the carbon fiber bundle is covered with a thermoplastic resin, and an axial length of the carbon fiber bundle is substantially the same as the length of the molding material. At this time, the carbon fiber bundle is the core and the thermoplastic resin is the sheath. The molding material preferably has a core-sheath structure in which the carbon fiber bundle is covered with a thermoplastic resin, and an axial length of the carbon fiber bundle is the same as the length of the molding material, and allows an error normally occurring when the covered body is cut with a cutter or the like. More specifically, the axial length of the carbon fiber bundle is preferably less than 5% with respect to the length of the molding material.

That is, the molding material is preferably a pellet having a core-sheath structure including the carbon fiber bundle as a core component and the thermoplastic resin as a sheath component, obtained by cutting a covered body in which the carbon fiber bundle is covered with the thermoplastic resin with a cutter (hereinafter, sometimes referred to as core-sheath pellets).

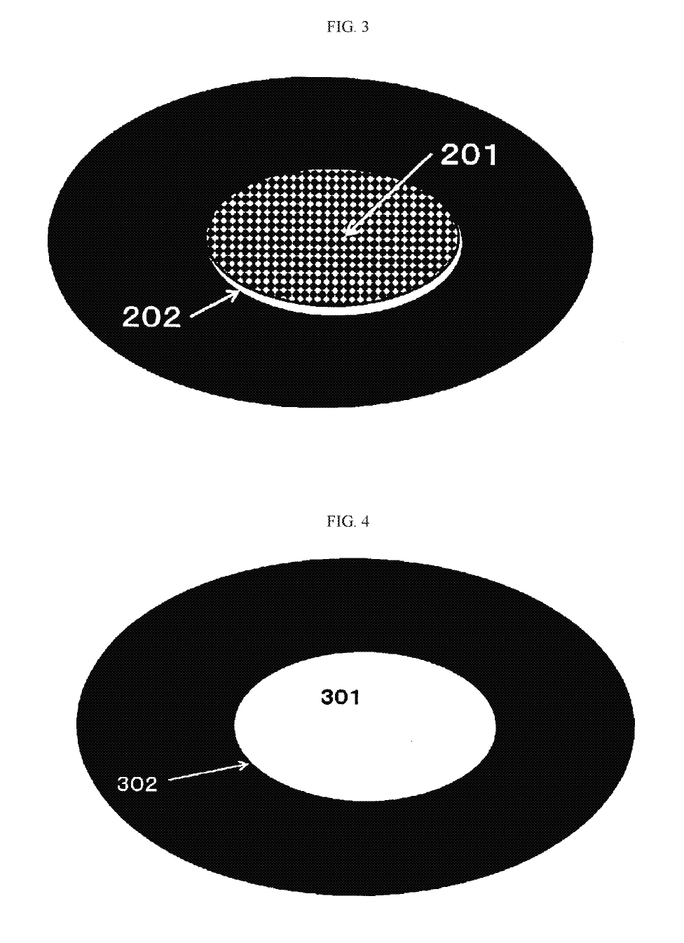

In such a granular molding material, the axial length of the carbon fiber bundle is preferably 1 mm to 30 mm, more preferably 2 mm to 10 mm, and even more preferably 2 mm to 5 mm. The diameter of the core-sheath pellets (for example, core-sheath pellets described in FIG. 3) is not particularly limited, and is preferably 1/10 or more and 2 times or less of the pellet length, and more preferably ¼ or more of the pellet length and equal to or less than the pellet length. The axial direction of the carbon fiber bundle is the longitudinal direction of the carbon single fiber in the carbon fiber bundle.

### [Impregnation State of Core-Sheath Structure and Impregnation Aid]

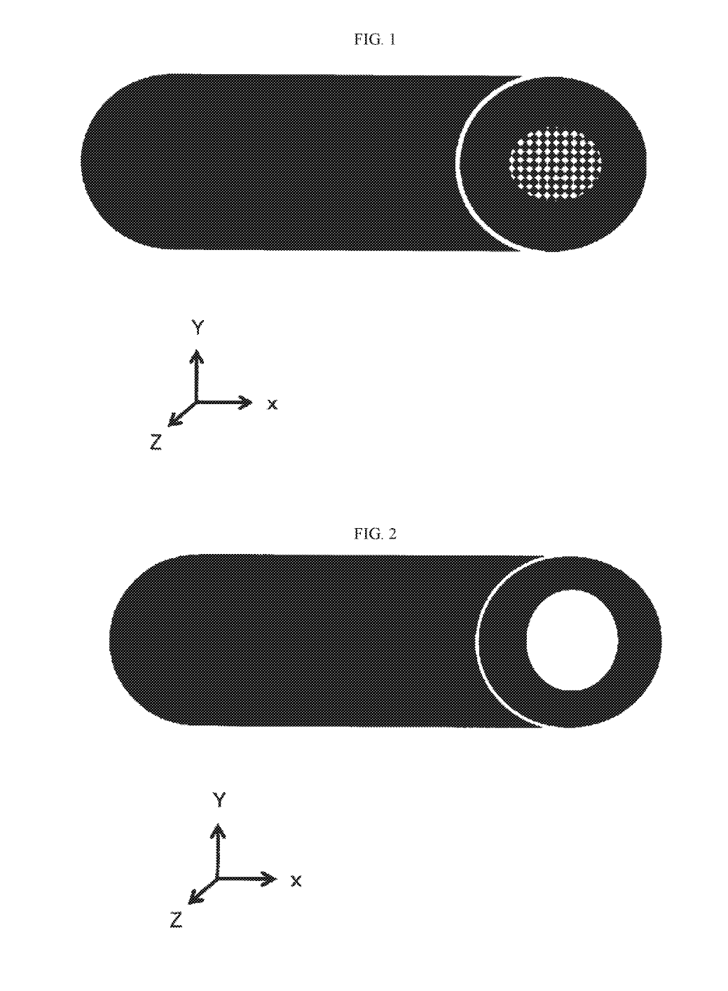

In the present invention, the carbon fiber bundle is preferably not impregnated with the thermoplastic resin. Here, the expression “the carbon fiber bundle is not impregnated with thermoplastic resin” means that the impregnation thickness of the thermoplastic resin in the direction toward the inside of the carbon fiber bundle is 50 μm or less when the molding material having a core-sheath structure in which the carbon fiber bundle is covered with the thermoplastic resin is cut in an axial center direction and is observed. The axial center direction refers to a direction toward the center of the axis (direction orthogonal to the axial direction of the carbon fiber bundle contained in the molding material), and the Z axis direction in FIG. 1 is the axial center direction.

When the carbon fiber bundle is impregnated with the thermoplastic resin of the molding material, the carbon fibers are difficult to fall out, but the production cost of the molding material is increased. The molding material according to the present invention is a molding material excellent in the viewpoint of production cost since it is difficult for the carbon fibers to fall out despite the fact that the carbon fiber bundle is not impregnated with the thermoplastic resin.

### [Assembly of Molding Materials]

The assembly of molding materials according to the present invention is an assembly of the above (granular) molding materials, and 30% or more of the molding materials in the assembly satisfy 100≤F/L (N/m), in which L represents the length of the molding material in the axial direction of the carbon fiber bundle and F represents the grip force of the carbon fiber bundle to the molding material.

100≤F/L (N/m) means that the carbon fibers are difficult to fall off from the molding material. The granular molding material forming the assembly of molding materials according to the present invention has, for example, a cylindrical shape as shown in FIG. 1. In a case where the carbon fibers in the carbon fiber bundle fall off from the molding material, it becomes a molding material of only the thermoplastic resin component, for example, as shown in FIGS. 2 and 4.

When the value of F/L is less than 80 (N/m), the carbon fibers are easy to fall off from the molding material. That is, when the value of F/L is less than 80 (N/m), troubles may occur not only in the steps of producing the molding material but also in the molding site using the molding material, such as falling off of the carbon fibers from the molding material when the molding material is dry-blended or pneumatically conveyed, and clogging in a hopper dryer of an injection molding machine.

Preferably 40% or more, more preferably 50% or more, and still more preferably 60% or more of the molding materials in the whole assembly satisfy 100≤F/L (N/m). When the above percentage is less than 30%, the amount of the carbon fiber falling off from the molding material during dry blending or in pneumatic conveying the assembly of molding materials is large, and the productivity of the molded body is lowered.

From the viewpoint of poor dispersion of the carbon fibers in injection molding, F/L is preferably less than 100,000 (N/m), and more preferably 10,000 (N/m) or less.

In the assembly of molding materials according the present invention, preferably 30% or more the molding materials in the whole assembly satisfy F/L (N/m)<100,000.

In the case of a core-sheath structure in which the carbon fiber bundle is covered with the thermoplastic resin, the grip force F of the carbon fiber bundle to the molding material can be measured as follows. That is, 100 molding materials were randomly taken out from the assembly of molding materials. Using a force gauge (manufactured by Imada) equipped with a pin having φ0.8 mm at the tip thereof, the pin is pushed into the carbon fiber bundle of the core portion of the molding material, and the maximum load is measured when the carbon fibers fall off. Here, since the measurement cannot be performed when the carbon fiber bundle has already fallen off from the molding material taken out, the grip force to this molding material was set to 0 (N).

As is clear from the above measurement method, the grip force of the carbon fiber bundle to the molding material indicates the force with which the carbon fiber bundle is gripped in the molding material.

The molding material according to the present invention is preferably a molding material in which a carbon fiber bundle containing an impregnation aid is covered with a thermoplastic resin, and which satisfies 80≤F/L (N/m) when the length of the molding material in the axial direction of the carbon fiber bundle is L and the grip force of the carbon fiber bundle to the molding material is F. Here, the F/L of the molding material is the average value of F/L of 100 molding materials. The molding material according to the present invention preferably has F/L (N/m) of 80 or more, more preferably 90 or more, still more preferably 150 or more, particularly preferably 200 or more, and most preferably 250 or more. In addition, the molding material according to the present invention preferably has F/L (N/m) of less than 100,000 (N/m), and more preferably 10,000 (N/m) or less.

In the case of a core-sheath structure in which the carbon fiber bundle is covered with the thermoplastic resin, the grip force F of the carbon fiber bundle to the molding material is measured as the average value of 100 randomly taken molding materials by the above measurement method.

### [Observation of Cross Section in Axial Center Direction]

In the assembly of molding materials according to the present invention, the molding material, which has a core-sheath structure in which the carbon fiber bundle is covered with the thermoplastic resin, preferably satisfies the following Formula (1) when the molding material is cut in the axial center direction and observed.

0.4≤(area of carbon single fiber)×(number of single fibers in carbon fiber bundle)/(area surrounded by inner periphery of thermoplastic resin)≤0.9 (1)

Here, the area surrounded by the inner periphery of the thermoplastic resin is an average value of the molding materials in the assembly.

The expression “(area of carbon single fiber)×(number of single fibers in carbon fiber bundle)” indicates only the area of the carbon fibers at the core portion when the molding material is cut in the axial center direction and is observed.

The area surrounded by the inner periphery of the thermoplastic resin is, for example, 202 shown in FIG. 3. In a case where the carbon fiber bundle (201) falls off from the molding material, the area surrounded by the inner periphery of the thermoplastic resin indicated by 302 in FIG. 4 may be measured since 301 in FIG. 4 is a cavity.

When the value of (area of carbon single fiber)×(number of single fibers in carbon fiber bundle)/(area surrounded by inner periphery of thermoplastic resin) is less than 0.4, the carbon fibers are easy to fall off from the molding material. Thus, the value is preferably 0.4 or more. More preferred range is 0.5 or more. From the viewpoint of poor dispersion of the carbon fibers in injection molding, (area of carbon single fiber)×(number of single fibers in carbon fiber bundle)/(area surrounded by inner periphery of thermoplastic resin) is preferably 0.9 or less.

### [Phase State of Impregnation Aid]

The impregnation aid in the present invention is preferably a solid substance at 20° C. Before producing the molding material according to the present invention, a carbon fiber bundle containing an impregnation aid may be prepared in advance. This is because the carbon fiber bundle containing the impregnation aid is stored, for example, in a state wound around a paper pipe or the like, and it is easy to unwind the fiber bundle when the impregnation aid is a solid substance at room temperature.

In the molding material according to the present invention, a ratio D₁/D₂ of the long diameter D₁ to the short diameter D₂ of the shape of the cross section obtained by cutting the molding material along the direction orthogonal to the axial direction of the carbon fiber bundle is preferably 1.1 to 1.8. The upper limit of D₁/D₂ is preferably 1.6 or less, more preferably 1.5 or less, and still more preferably 1.4 or less. The lower limit of D₁/D₂ is preferably 1.2 or more. The shape of the cross section obtained by cutting the molding material along the direction orthogonal to the axial direction of the carbon fiber bundle is preferably an ellipse or a circle.

When D₁/D₂ is small, the carbon fiber bundle tends to fall off from the molding material. This is because the carbon fiber bundle can be crushed with the thermoplastic resin and thus the carbon fiber bundle is difficult to fall off in the case of a flat-shaped molding material having large D₁/D₂. In the present invention, even with a molding material having D₁/D₂ within the above range, the carbon fiber bundle can be gripped by the molding material.

The long diameter (D₁) of the cross section of the molding material refers to the maximum diameter in the shape of the cross section of the molding material, and the short diameter refers to the maximum diameter of the diameter in the direction perpendicular to the long diameter.

In the molding material according to the present invention, it is preferable that 100×(D₁/D₂)/Wf, which is a relationship between D₁/D₂ and a carbon fiber content ratio Wf (carbon fiber mass fraction, unit:mass %), is 2.0 to 40.0.

The upper limit of 100×(D₁/D₂)/Wf is preferably 20.0 or less, more preferably 9.0 or less, and still more preferably 8.0 or less. The lower limit of 100×(D₁/D₂)/Wf is preferably 3.0 or more, and more preferably 4.0 or more.

When 100×(D₁/D₂)/Wf is 40.0 or less, the carbon fiber bundle tends to fall off from the molding material. This is because a molding material having a high carbon fiber content ratio (carbon fiber mass fraction, Wf unit:mass %), of course, has a large fraction of the carbon fiber bundle, and the carbon fiber bundle tends to fall off from the molding material. In the present invention, even with a molding material having 100×(D₁/D₂)/Wf within the above preferred range, the carbon fiber bundle can be gripped by the molding material.

The carbon fiber content ratio (carbon fiber mass fraction, Wf unit:mass %) is the fraction of the mass of the carbon fiber to the total mass including not only the carbon fibers and the thermoplastic resin but also the impregnation aid.

### [Method for Producing Molding Material]

### 1. Covering

The method for producing the molding material according to the present invention is a method for producing a core-sheath-structure molding material in which a carbon fiber bundle containing an impregnation aid is covered with a thermoplastic resin, and the method preferably includes: covering the carbon fiber bundle with the thermoplastic resin to be integrated in a heated state where the carbon fiber bundle is heated to a temperature equal to or higher than a melting point of the impregnation aid when the impregnation aid is a crystalline resin, or to a temperature equal to or higher than a glass transition temperature of the impregnation aid when the impregnation aid is an amorphous resin.

This is because the voids in the carbon fiber bundle of the molding material can be reduced by heating the impregnation aid contained (sometimes solidified) in the carbon fiber bundle to a temperature higher than the melting point or glass transition temperature thereof to liquefy or soften the impregnation aid, and covering the carbon fiber bundle with the thermoplastic resin in a state where the carbon fiber bundle is easy to bundled, thereby the carbon fibers can be prevented from falling off from the molding material.

By heating the carbon fiber bundle to a temperature higher than the melting point or the glass transition temperature of the thermoplastic resin for covering the carbon fiber bundle, sudden solidification of the thermoplastic resin near the interface between the carbon fiber bundle and the thermoplastic resin is prevented, and interfacial peeling immediately after covering the carbon fiber bundle with thermoplastic resin is prevented. Thereby, the familiarity at the interface between the carbon fiber bundle and the thermoplastic resin can be improved.

In the present specification, the above step of heating the impregnation aid in advance may be referred to as “preheating” in some cases.

### 2. Cooling

It is preferable that the molding material according to the present invention is produced by: producing a covered body, in which the carbon fiber bundle is covered with the thermoplastic resin to be integrated; and cutting the covered body. The covered body in the present specification refers to one before being cut after the carbon fiber bundle is covered with the thermoplastic resin.

The covered body is preferably cut after being cooled to a temperature lower than the glass transition temperature of the thermoplastic resin covering the carbon fiber bundle. The present inventors consider that, by cooling and then cutting the covered body, the thermoplastic resin covering the carbon fiber bundle becomes hard to some extent from the soft state, the shear stress during the cutting concentrates, the shear stress for cutting the core carbon fiber bundle is sufficient, and the carbon fiber bundles fallen off from the covered body as if picked out from the covered body are reduced.

### [Water Content Ratio in Carbon Fiber]

The assembly of molding materials according to the present invention preferably satisfies 0.001≤W (w %)<0.4 when the water content of the carbon fiber bundle containing the impregnation aid is W (wt %). The water content ratio (wt %) of the carbon fiber bundle is a ratio with respect to 100 wt % of the carbon fiber bundle, and is represented by the following Formula (4).

(Water content ratio (wt %) of carbon fiber bundle)=(water content (wt) contained in carbon fibers)/(weight (wt) of carbon fiber bundle containing water)×100 (4)

If the water content ratio W of the carbon fiber bundle is small, the voids in the carbon fiber bundle of the molding material is seldom enlarged by the water evaporated and expanded in the covered body when the carbon fiber bundle is covered with the thermoplastic resin, so that it is possible to prevent the carbon fiber from falling off from the molding material. The water content ratio W (wt %) of the carbon fiber bundle is preferably less than 0.4 (wt %), and more preferably less than 0.2 (wt %).

### [Application of Assembly of Molding Materials]

The assembly of molding materials according to the present invention is used as a material for injection molding. The molding material according to the present invention can be produced by a simple process and has an advantage of being able to produce an injection molded body with high production efficiency.

### EXAMPLES

### [Evaluation and Analysis Methods]

Examples are shown below, but the present invention is not limited thereto. Values in this example were determined according to the following methods.

### (Content or Content Ratio of Surface Treatment Agent)

The carbon fiber bundle was cut at a length of 1 m, charged into a crucible. The crucible was placed in a muffle furnace set at a furnace temperature of 550° C. for 15 minutes, the surface treatment agent component was burned off. The amount of the surface treatment agent such as the impregnation aid contained in the carbon fiber bundle was determined based on the mass of the remained carbon fibers.

(Fraction of Molding Material from which Carbon Fibers Fall Off (Number Fraction))

1000 molding materials were randomly taken out from the obtained assembly of molding materials. Among the 100 molding materials, the number of the molding material from which the carbon fibers fall out was counted. The number fraction of the molding material from which the carbon fibers fall off was calculated according to the following Formula (5).

Molding materials from which carbon fibers fall off (number)/1000 (number)×100 (5)

(Carbon Fiber Fall Off Rate (Weight Fraction) in Shaking Test) Approximately 250 g of the assembly of molding materials produced in each example and comparative example was weighed and placed in a sieve having an opening of 2 mm and shaken for 1 minute. Next, the assembly of the molding materials from which the fibers fall off due to shaking was taken out from the sifter, the amount of the carbon fibers fell off was measured based on the weights before and after shaking, and the carbon fiber fall off rate (weight fraction) was calculated according to the following Formula (6).

Carbon fiber fall off amount (g)/assembly of weighed molding material (g)×100 (6)

### (Grip Force of Carbon Fiber Bundle to Molding Material)

100 molding materials were randomly taken out from the obtained assembly of molding materials, a pin of φ0.8 mm was pushed into the carbon fiber bundle of the core portion of the molding material using a force gauge (manufactured by Imada) equipped with the pin at the tip, and the maximum load was measured when the carbon fibers fell off. Here, since the measurement cannot be performed when the carbon fiber bundle had already fallen off from the molding material taken out, the grip force by this molding material was set to 0 (N).

F/L (N/m) was obtained by using the average value of the grip forces by 100 molding materials taken out as F(N) and dividing this F by the pellet length L of the obtained molding material.

Next, the number of the molding material having F/L of 100 (N/m) or more was counted from the obtained 100 molding materials, and the proportion (%) of the molding material satisfying 100≤F/L of the assembly of molding materials was calculated according to the following Formula (7).

(Number of molding material satisfying 100≤F/L)/100 (number)×100 (7)

### [Area Surrounded by Inner Periphery of Thermoplastic Resin]

100 molding materials (core-sheath structure) were randomly taken out from the obtained assembly of molding materials. A cross section cut in the axial center direction of the molding material was observed with a digital microscope (VHX-1000) manufactured by Keyence Corporation, and the area surrounded by the inner periphery of the thermoplastic resin was calculated. The average value of 100 molding materials taken out was defined as the area surrounded by the inner periphery of the thermoplastic resin (the thermoplastic resin is a sheath in the core-sheath structure). Next, the value of the following Formula (1) was calculated using the (area of carbon single fiber) and (number of single fibers in carbon fiber bundle), used in Examples and Comparative Examples of the present invention.

(Area of Carbon single fiber)×(number of single fibers in carbon fiber bundle)/(area surrounded by inner periphery of thermoplastic resin) (1)

### [Preparation of Raw Material]

The raw materials used in the present invention are as follows.

### (Carbon Fiber Bundle)

PAN-based carbon fiber: STS40-24K manufactured by Toho Tenax Co.

Carbon single fiber diameter: 7.0 μm; number of filaments: 24000; tensile strength: 4000 MPa

### (Impregnation Aid)

1. polycaprolactone, which is an aliphatic hydroxycarboxylic acid-based polyester, (PLACCEL (registered trademark) H1P manufactured by Daicel Corporation, molecular weight: 10000)

2. triphenyl phosphate (TPP manufactured by Daihachi Chemical Industry Co., Ltd.)

3. bisphenol A bis(diphenyl phosphate) (CR-741 manufactured by Daihachi Chemical Industry Co., Ltd.)

### (Thermoplastic Resin)

Polycarbonate: L-1225Y manufactured by Teijin Ltd.

Glass transition temperature: 150° C.

Linear expansion coefficient (10⁻⁴/° C.): 0.7

Solubility parameter ((cal/cm³)^{1/2}): 9.7

### Example 1

A polycaprolactone (PLACCEL (registered trademark) H1P manufactured by Daicel Corporation, molecular weight: 10000) was used as an impregnation aid, was emulsified to a nonvolatile content of 20 mass %, and a carbon fiber bundle was passed through the emulsified solution, and then the excessively adhering solution was removed from the carbon fiber bundle with a nip roll. Thereafter, the carbon fiber bundle was passed through a hot air drying oven heated to 180° C. over 2 minutes to be dried, thereby a carbon fiber bundle containing the impregnation aid was obtained. Thereafter, the carbon fiber bundle was subjected again to a heat treatment by placing the carbon fiber bundle along two metal rolls, having a diameter of 60 mm and heated to 200° C., so that the water content ratio contained in the carbon fiber bundle was 0.1 wt %. The content of the impregnation aid contained in the carbon fiber bundle was 10 parts by mass based on 100 parts by mass of the carbon fibers.

Next, the carbon fiber bundle containing the impregnation aid obtained as described above was covered with a polycarbonate (L-1225Y manufactured by Teijin Ltd.) using a crosshead die for electric wire covering having an outlet diameter of 3 mm, in a state where the carbon fiber bundle was heated to 60° C. by placing along two metal rolls, having a diameter of 60 mm and heated to 100° C., so as to produce a covered body. (The heating may be referred to as preheating in some cases. The phase state of the impregnation aid after the preheating was liquid.) The covered body was cooled through a water bath circulating cooling water at 20° C. At this time, the temperature of the covered body was measured using a radiation thermometer, being 120° C. Thereafter, the covered body was cut into a length of 3 mm with a pelletizer to obtain molding materials that are core-sheath pellets with a carbon fiber content ratio (Wf (carbon fiber mass fraction)) of 20 mass % (for 100 parts by mass of the carbon fibers, 394.7 parts by mass of the polycarbonate), a diameter of 3.2 mm and a length of 3 mm and suitable for injection molding.

The molding material was continuously manufactured to produce 10,000 molding materials (an assembly of molding materials). The results are shown in Table 1.

Since the linear expansion coefficient K₁ (10⁻⁴/° C.) of the thermoplastic resin is 0.7 and the linear expansion coefficient K₂ (10⁻⁴/° C.) of the impregnation aid is 1.2, |K₁−K₂| is 0.5; since the solubility parameter (SP) value S₁ ((cal/cm³)^{1/2}) of the thermoplastic resin is 9.7 and the SP value S₂ ((cal/cm³)^{1/2}) of the impregnation aid is 10.2, |S₁−S₂| is 0.5.

The molding material was subjected to injection molding at cylinder temperatures C1/C2/C3/C4/N=280° C./290° C./300° C./300° C./300° C. (C1 to C4 were cavities and N was a nozzle) at a molding cycle of 35 seconds using a 110 ton electric injection molding machine (J110AD) manufactured by the Japan Steel Works, LTD., to obtain a tumbling dumbbell having a thickness of 4 mm During the molding, the carbon fibers did not fall off from the core-sheath pellets, and troubles in molding did not occur.

100 molding materials were randomly taken out from the obtained assembly of molding materials. Each molding material was cut in the direction perpendicular to the axial direction of the carbon fiber bundle of the molding material. The long diameter (D₁) and the short diameter (D₂) of each cross section of the carbon fiber bundle were measured to obtain the average value, and then D₁/D₂ was calculated to be 1.25. Since the carbon fiber content ratio of the molding material of Example 1 is 20 mass %, 100×(D₁/D₂)/Wf is calculated to be 100×1.25/20=1.25/0.2 6.3.

### Example 2

An assembly of molding materials was prepared in the same manner as in Example 1 except that the temperature of the carbon fiber bundle in preheating was changed from 60° C. to 170° C. The results are shown in Table 1.

### Example 3

An assembly of molding materials was prepared in the same manner as in Example 1 except that the carbon fiber weight fraction (wf) was changed from 20 mass % to 40 mass %. The results are shown in Table 1.

100 molding materials were randomly taken out from the obtained assembly of molding materials. Each molding material was cut in the direction perpendicular to the axial direction of the carbon fiber bundle of the molding material. The long diameter (D₁) and the short diameter (D₂) of each cross section of the carbon fiber bundle were measured to obtain the average value, and then D₁/D₂ was calculated to be 1.46. Since the carbon fiber content ratio of the molding material of Example 3 is 40 mass %, 100×(D₁/D₂)/Wf is calculated to be 100×1.46/40%=1.46/0.4≈3.7.

### Example 4

An assembly of molding materials was prepared in the same manner as in Example 1 except that the length of the molding material (the length of the core-sheath pellets) was 1 mm. The results are shown in Table 1.

### Example 5

An assembly of molding materials was prepared in the same manner as in Example 1 except that the length of the molding material (the length of the core-sheath pellets) was 10 mm. The results are shown in Table 1.

### Example 6

Carbon fibers were coated with a thermoplastic resin in the same manner as in Example 1 except that the temperature of the cooling water was set at 80° C. The temperature of the covered body was increased from 120° C. to 160° C. The results are shown in Table 1.

### Example 7

An assembly of molding materials was prepared in the same manner as in Example 1 except that the water content ratio contained in the used carbon fiber bundle was changed from 0.1 wt % to 0.4 wt % by preparing the carbon fiber bundle without performing the heat treatment again in Example 1 (along two metal rolls having a diameter of 60 mm heated to 200° C.). The results are shown in Table 1.

### Example 8

An assembly of molding materials was prepared in the same manner as in Example 1 except that triphenyl phosphate was used rather than the polycaprolactone as the impregnation aid, and the temperature of the carbon fiber bundle in preheating was brought to 170° C. The results are shown in Table 1.

Since the solubility parameter (SP) value S₁ ((cal/cm³)^{1/2}) of the thermoplastic resin is 9.7 and the SP value S₂ ((cal/cm³)^{1/2}) of the impregnation aid is 10.5, |S₁−S₂| is 0.8.

### Example 9

An assembly of molding materials was prepared in the same manner as in Example 1 except that bisphenol A bis(diphenyl phosphate) was used rather than the polycaprolactone as the impregnation aid, and the temperature of the carbon fiber bundle in preheating was brought to 170° C. The results are shown in Table 1.

Since the solubility parameter (SP) value S₁ ((cal/cm³)^{1/2}) of the thermoplastic resin is 9.7 and the SP value S₂ ((cal/cm³)^{1/2}) of the impregnation aid is 10.3, |S₁−S₂| is 0.6.

### Comparative Example 1

An assembly of molding materials was prepared in the same manner as in Example 1 except that the carbon fiber bundle was not preheated when covering the carbon fiber bundle with the thermoplastic resin, and the temperature during the covering was 30° C., so as to produce a molding material with keeping the phase state of the impregnation aid in a solid state during the covering. The results are shown in Table 1.

### Comparative Example 2

An assembly of molding materials was prepared in the same manner as in Example 1 except that the carbon fiber bundle was preheated to adjust the temperature of the carbon fiber bundle to 170° C., then the carbon fiber bundle was once cooled, and the temperature when covering the carbon fiber bundle with the thermoplastic resin was 30° C., so as to produce a molding material. The results are shown in Table 1.

The molding materials of all the examples had the same the axial length of the carbon fiber bundle and the length of the molding material. In addition, in the molding materials of all the examples, the carbon fiber bundles were not impregnated with the thermoplastic resin (when the molding material was cut in the axial center direction and was observed, the thickness of the thermoplastic resin penetrating into the carbon fiber bundle direction was 50 μm or less). In the assembly of the molding materials of all the examples, 30% or more of the molding materials in the assembly satisfy F/L (N/m)<100,000.

TABLE 1

| | Example 1 | Example 2 | Example 3 | Example 4 | Example 5 | Example 6 |
|---|---|---|---|---|---|---|
| Water content ratio of carbon fiber bundle | 0.1 | 0.1 | 0.1 | 0.1 | 0.1 | 0.1 |
| Thermoplastic resin | PC*¹ | PC | PC | PC | PC | PC |
| Impregnation aid | | | | | | |
| Type | PCL*² | PCL | PCL | PCL | PCL | PCL |
| Melting point | 60° C. | 60° C. | 60° C. | 60° C. | 60° C. | 60° C. |
| State of impregnation aid at 20° C. | Solid | Solid | Solid | Solid | Solid | Solid |
| Linear expansion coefficient (10⁻⁴/° C.) | 1.2 | 1.2 | 1.2 | 1.2 | 1.2 | 1.2 |
| Solubility parameter ((cal/cm³)^{1/2}) | 10.2 | 10.2 | 10.2 | 10.2 | 10.2 | 10.2 |
| Amount based on 100 parts by mass of carbon fibers | 10 | 10 | 10 | 10 | 10 | 10 |
| Method for producing molding material | | | | | | |
| Preheating temperature | 60° C. | 170° C. | 60° C. | 60° C. | 60° C. | 60° C. |
| Temperature of carbon fiber bundle when being covered | 60° C. | 170° C. | 60° C. | 60° C. | 60° C. | 60° C. |
| with thermoplastic resin | | | | | | |
| Phase state of impregnation aid when covering carbon | Liquid | Liquid | Liquid | Liquid | Liquid | Liquid |
| fiber bundle with thermoplastic resin | | | | | | |
| Temperature of covered body when being cut | 120° C. | 120° C. | 120° C. | 120° C. | 120° C. | 160° C. |
| Molding material | | | | | | |
| Wf (wt %) | 20% | 20% | 40% | 20% | 20% | 20% |
| Length L of molding material in axial direction of | 3 | 3 | 3 | 1 | 10 | 3 |
| carbon fiber bundle (mm) | | | | | | |
| Assembly of molding materials | | | | | | |
| Number fraction of molding material from which carbon | 0.0% | 0.0% | 0.0% | 0.0% | 0.0% | 0.8% |
| fibers fall off in 1000 molding materials | | | | | | |
| Carbon fiber fall off rate | 0.0% | 0.0% | 0.0% | 0.0% | 0.0% | 0.1% |
| Grip force F of carbon fiber bundle by molding material | 0.76 | 2.32 | 0.71 | 0.22 | 4.95 | 0.46 |
| (N) | | | | | | |
| F/L (N/m) | 253 | 773 | 237 | 209 | 495 | 153 |
| Proportion of molding material satisfying 100 ≤ F/L | 100% | 100% | 100% | 100% | 100% | 48% |
| Area of core portion of core-sheath pellets (mm²) | 1.79 | 1.71 | 1.81 | 1.80 | 1.78 | 2.05 |
| (Area of Carbon single fiber) × (number of single fibers | 0.52 | 0.54 | 0.51 | 0.51 | 0.52 | 0.45 |
| in carbon fiber bundle)/(area surrounded by inner | | | | | | |
| periphery of thermoplastic resin (sheath)) | | | | | | |

| | | | | Comparative | Comparative |
|---|---|---|---|---|---|
| | Example 7 | Example 8 | Example 9 | Example 1 | Example 2 |
| Water content ratio of carbon fiber bundle | 0.4 | 0.1 | 0.1 | 0.1 | 0.1 |
| Thermoplastic resin | PC | PC | PC | PC | PC |
| Impregnation aid | | | | | |
| Type | PCL | Triphenyl | Bisphenol A | PCL | PCL |
| | | phosphate | bis(diphenyl | | |
| | | | phosphate) | | |
| Melting point | 60° C. | 50° C. | 5° C. | 60° C. | 60° C. |
| State of impregnation aid at 20° C. | Solid | Solid | Liquid | Solid | Solid |
| Linear expansion coefficient (10⁻⁴/° C.) | 1.2 | — | — | 1.2 | 1.2 |
| Solubility parameter ((cal/cm³)^{1/2}) | 10.2 | 10.5 | 10.3 | 10.2 | 10.2 |
| Amount based on 100 parts by mass of carbon fibers | 10 | 10 | 10 | 10 | 10 |
| Method for producing molding material | | | | | |
| Preheating temperature | 60° C. | 170° C. | 170° C. | — | 170° C. |
| Temperature of carbon fiber bundle when being covered | 60° C. | 170° C. | 170° C. | 30° C. | 30° C. |
| with thermoplastic resin | | | | | |
| Phase state of impregnation aid when covering carbon | Liquid | Liquid | Liquid | Solid | Solid |
| fiber bundle with thermoplastic resin | | | | | |
| Temperature of covered body when being cut | 120° C. | 120° C. | 120° C. | 120° C. | 120° C. |
| Molding material | | | | | |
| Wf (wt %) | 20% | 20% | 20% | 20% | 20% |
| Length L of molding material in axial direction of | 3 | 3 | 3 | 3 | 3 |
| carbon fiber bundle (mm) | | | | | |
| Assembly of molding materials | | | | | |
| Number fraction of molding material from which carbon | 2.9% | 0.0% | 0.0% | 12.1% | 7.1% |
| fibers fall off in 1000 molding materials | | | | | |
| Carbon fiber fall off rate | 0.5% | 0.0% | 0.0% | 1.9% | 1.1% |
| Grip force F of carbon fiber bundle by molding material | 0.27 | 1.53 | 1.68 | 0.21 | 0.23 |
| (N) | | | | | |
| F/L (N/m) | 90 | 510 | 560 | 70 | 77 |
| Proportion of molding material satisfying 100 ≤ F/L | 32% | 100% | 100% | 25% | 29% |
| Area of core portion of core-sheath pellets (mm²) | 2.12 | 1.76 | 1.74 | 2.66 | 2.48 |
| (Area of Carbon single fiber) × (number of single fibers | 0.44 | 0.52 | 0.53 | 0.35 | 0.37 |
| in carbon fiber bundle)/(area surrounded by inner | | | | | |
| periphery of thermoplastic resin (sheath)) | | | | | |

*¹PC: abbreviation of polycarbonate
*²PCL: abbreviation of polycaprolactone

### INDUSTRIAL APPLICABILITY

When the assembly of the molding materials according to the present invention is used, it is possible to prevent the carbon fibers from falling off from the molding material during injection molding and to produce a molded body with high production efficiency. In addition, when the assembly of the molding materials according to the present invention is used, troubles in molding such as clogging in a hopper dryer of a molding machine during injection molding are reduced and the handleability is excellent.

While the present invention has been described in detail and with reference to specific embodiments, it will be apparent to those skilled in the art that various changes and modifications can be made without departing from the spirit and scope of the invention.

This application is based on Japanese patent application (Japanese patent application No. 2016-214221) filed on Nov. 1, 2016, the contents of which are incorporated herein by reference.

### DESCRIPTION OF REFERENCE NUMERALS

201 Carbon fiber bundle
202 Inner periphery of thermoplastic resin
301 Cavity obtained after carbon fiber bundle falls off
302 Inner periphery of thermoplastic resin

1. An assembly of molding materials, each of which comprising:
a carbon fiber bundle containing an impregnation aid; and
a thermoplastic resin covering the carbon fiber bundle,
wherein 30% or more of the molding materials in the assembly satisfy 100≤F/L (N/m),
wherein L represents a length of each molding material in an axial direction of the carbon fiber bundle, and F represents a grip force of the carbon fiber bundle to the molding material.

2. The assembly of molding materials according to claim 1,
wherein the molding material has a core-sheath structure in which the carbon fiber bundle is covered with a thermoplastic resin, and an axial length of the carbon fiber bundle is substantially the same as the length of the molding material.

3. The assembly of molding materials according to claim 2, wherein each of the molding materials satisfies the following Formula (1) when the molding material cut in an axial center direction thereof is observed:
0.4≤(area of carbon single fiber)×(number of single fibers in carbon fiber bundle)/(area surrounded by inner periphery of thermoplastic resin)≤0.9 (1)
wherein, the area surrounded by the inner periphery of the thermoplastic resin is an average value of the molding materials in the assembly.

4. The assembly of molding materials according to claim 1, wherein the impregnation aid is one or more selected from the group consisting of a phosphate ester and an aliphatic hydroxycarboxylic acid based polyester.

5. The assembly of molding materials according to claim 1, wherein the impregnation aid is a solid substance at 20° C.

6. The assembly of molding materials according to claim 1, satisfying the following Formula (2):
0.1≤|K₁−K₂| (2)
wherein, K₁ (10⁻⁴/° C.) represents a linear expansion coefficient of the thermoplastic resin, and
K₂ (10⁻⁴/° C.) represents a linear expansion coefficient of the impregnation aid.

7. The assembly of molding materials according to claim 1, satisfying the following Formula (3):

|S₁−S₂|<1.5 (3)
wherein, S₁ ((cal/cm³)^{1/2}) represents a solubility parameter (SP) value of the thermoplastic resin, and
S₂ ((cal/cm³)^{1/2}) represents an SP value of the impregnation aid.

8. The assembly of molding materials according to claim 1, wherein axial lengths of the carbon fiber bundles are 1 mm to 30 mm.

9. The assembly of molding materials according to claim 2, wherein the thermoplastic resin contains an amorphous resin.

10. The assembly of molding materials according to claim 2, wherein the thermoplastic resin contains a polycarbonate.

11. The assembly of molding materials according to claim 1, wherein the carbon fiber bundles are not impregnated with the thermoplastic resin.

12. The assembly of molding materials according to claim 1, wherein 30% or more of the molding materials in the assembly satisfy F/L (N/m)<100,000.

13. The assembly of molding materials according to claim 1,
wherein the carbon fiber bundles satisfy 0.001≤W (wt %)≤0.4,
wherein W (wt %) is a water content ratio in the carbon fiber bundles containing the impregnation aid.

14. The assembly of molding materials according to claim 1, wherein a ratio of D₁/D₂ is 1.1 or more and 1.8 or less,
wherein D₁ represents a long diameter D₁ of a cross section shape of the molding material cut along a direction orthogonal to the axial direction of the carbon fiber bundle, and
D₂ represents a short diameter D₂ of the cross section shape.

15. A method for producing a molding material having a core-sheath-structure in which a carbon fiber bundle containing an impregnation aid is covered with a thermoplastic resin, the method comprising:
covering the carbon fiber bundle with the thermoplastic resin to be integrated in a heated state where the carbon fiber bundle is heated to a temperature equal to or higher than a melting point of the impregnation aid when the impregnation aid is a crystalline resin, or heating the carbon fiber bundle to a temperature equal to or higher than a glass transition temperature of the impregnation aid when the impregnation aid is an amorphous resin.

16. A method for producing an assembly of molding materials which are produced using the method for producing a molding material according to claim 15,
wherein 30% or more of the molding materials in the assembly satisfy 100≤F/L (N/m)≤100,000,
wherein L represents a length of the molding material in an axial direction of the carbon fiber bundle, and
F represents a grip force of the carbon fiber bundle to the molding material.

17. The method for producing a molding material according to claim 15, further comprising:
cooling a covered body produced by covering the carbon fiber bundle with the thermoplastic resin to be integrated to be equal to or lower than the glass transition temperature of the thermoplastic resin; and
cutting the covered body to produce the molding material.

18. The method for producing a molding material according to claim 15, wherein
a water content ratio in the carbon fiber bundle containing the impregnation aid W (wt %) satisfies 0.001≤W (wt %)<0.4.

19. A molding material comprising:
a carbon fiber bundle containing an impregnation aid; and
a thermoplastic resin covering the carbon fiber bundle,
wherein the molding material satisfies 80≤F/L (N/m),
wherein L represents a length of the molding material in an axial direction of the carbon fiber bundle, and
F represents a grip force of the carbon fiber bundle to the molding material.

20. The molding material according to claim 19, wherein the molding material has a core-sheath structure in which the carbon fiber bundle is covered with the thermoplastic resin, and an axial length of the carbon fiber bundle is substantially the same as the length of the molding material.

21. The molding material according to claim 20, wherein the molding material satisfies the following Formula (1) when the molding material cut in an axial center direction thereof is observed:
0.4≤(area of carbon single fiber)×(number of single fibers in carbon fiber bundle)/(area surrounded by inner periphery of thermoplastic resin)≤0.9 (1).

22. The molding material according to claim 19, wherein the impregnation aid is one or more selected from the group consisting of a phosphate ester and an aliphatic hydroxycarboxylic acid-based polyester.

23. The molding material according to claim 19, wherein the impregnation aid is a solid substance at 20° C.

24. The molding material according to claim 19, satisfying the following Formula (2):
0.1≤|K₁−K₂| (2)
wherein, K₁ (10⁻⁴/° C.) represents a linear expansion coefficient of the thermoplastic resin, and
K₂ (10⁻⁴/° C.) represents a linear expansion coefficient of the impregnation aid.

25. The molding material according to claim 19, satisfying the following Formula (3):

|S₁−S₂|<1.5 (3)
wherein S₁ ((cal/cm³)^{1/2}) represents a solubility parameter (SP) value of the thermoplastic resin, and
S₂ ((cal/cm³)^{1/2}) represents an SP value of the impregnation aid.

26. The molding material according to claim 19, wherein an axial length of the carbon fiber bundle is 1 mm to 30 mm.

27. The molding material according to claim 19, wherein the thermoplastic resin contains an amorphous resin.

28. The molding material according to claim 19, wherein the thermoplastic resin contains a polycarbonate.

29. The molding material according to claim 19, wherein the carbon fiber bundle is not impregnated with the thermoplastic resin.

30. The molding material according to claim 19, satisfying F/L (N/m)<100,000.

31. The molding material according to claim 19,
wherein the carbon fiber bundle satisfies 0.001≤W (wt %)<0.4,
wherein W (wt %) represents a water content ratio in the carbon fiber bundle containing the impregnation aid.

32. The molding material according to claim 19, wherein a ratio of D₁/D₂ is 1.1 to 1.8,
wherein D₁ represents a long diameter D₁ of a cross section shape of the molding material cut along a direction orthogonal to the axial direction of the carbon fiber bundle, and
D₂ represents a short diameter D₂ of the cross section shape.
